(19) United States
(12) Patent Application Publication
(10) Pub. No.: US 2026/0319808 A1
(43) Pub. Date: Oct. 15, 2026

(54) REMOTE COMPUTING DEVICE TO CONFIGURE HOST STORAGE DRIVES

(71) Applicant: Hewlett-Packard Development Company, L.P., Spring, TX (US)

(72) Inventors: Bryan Heckman, Fort Collins, CO (US); Matthew Bradow, Fort Collins, CO (US); Peter Andrew Seiler, Fort Collins, CO (US); J. Michael Stahl, Fort Collins, CO (US); Joseph-Jonathan Salzano, Fort Collins, CO (US); Dylan James Lea, Fort Collins, CO (US)

(73) Assignee: Hewlett-Packard Development Company, L.P., Spring, TX (US)

(21) Appl. No.: 19/484,337

(22) PCT Filed: May 19, 2023
(86) PCT No.: PCT/US2023/022967

§ 371 Date: Nov. 13, 2025

(51) Int. Cl. G06F 9/4401

(52) U.S. Cl. CPC G06F 9/4416

(57) ABSTRACT

A remote management peripheral device is a computing device that may be used alone or in connection with a server computing device to manage a fleet of host computing devices. A remote management peripheral device may also be used to directly command the erasure or backup of storage drives located on the host computing devices of the fleet. More specifically, the remote management peripheral device can, in accordance with a configuration option selected by an administrative user, generate a command to the BIOS of individual host computing devices within a fleet of host computing devices to erase or backup their respective storage drives.

### BACKGROUND

Generally described, computing devices can be configured with settings and commands implemented upon powering on the device. Utilizing such settings and commands often requires physical access to the computing devices. However, not all computing devices are conveniently accessible to users, such as administrative users, who need to access the settings and commands of the computing devices, particularly when the computing devices are among a fleet of computing devices utilized by an entity or enterprise. For example, an administrative user may be physically situated away from the fleet of computing devices but may need to access individual computing devices of the fleet in order to provide updates to, or manage storage resources among, the computing devices of the fleet.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1A is a pictorial diagram depicting an example fleet of host computing devices, such as workstation computers, that can communicate via a network and be managed by a remote management peripheral device according to basic input/output system (BIOS) commands generated by the remote management peripheral device in accordance with configuration options selected by a user of an administrative computing device.

FIG. 1B is a pictorial diagram of an example graphical user interface that is displayed at the administrative computing device and that presents configuration options provided by the remote management peripheral device for configuring storage drives of the host computing devices managed by the remote management peripheral device.

FIG. 2 is a block diagram depicting example interactions between an administrative computing device, a remote management peripheral device, and a host computing device of a fleet as shown in FIG. 1A, when a configuration option is selected at the administrative computing device via a user interface as shown in FIG. 1B and a BIOS command is generated by the remote management peripheral device.

FIG. 3 is a flow diagram depicting an example routine implemented by the remote management peripheral device for generating, in accordance with the configuration option selected at the administrative computing device, a BIOS command for erasure or backup of a storage drive of the host computing device and providing the BIOS command to the host computing device for execution by the BIOS of the host computing device.

FIG. 4 is a flow diagram depicting an example routine implemented by the remote management peripheral device for providing the host computing device with information related to backing up the storage drive of the host computing device when the BIOS command is a backup command.

FIG. 5 is a block diagram of an example architecture of a remote management peripheral device that generates a BIOS command in accordance with the configuration option selected at the administrative computing device.

FIG. 6 is a block diagram of an example architecture of a host computing device that executes a BIOS command received from the remote management peripheral device.

### DETAILED DESCRIPTION

Generally described, a remote management peripheral device is a computing device that may be used alone or in connection with a server computing device to manage a fleet of host computing devices utilized by an entity or enterprise. In some examples, the fleet of host computing devices includes workstation computers; however, in other examples, the fleet of computing devices includes workstation computers, laptop computers, notebook computers, desktop computers, any other computing devices capable of communicating via a network, or a combination thereof. The remote management peripheral device may be used to perform out-of-band management tasks on the fleet of host computing devices such as pre-boot access, BIOS updates, and re-imaging, without modifying network configurations for host computing devices within the fleet, without using a virtual private network connection with individual host computing devices, and/or without requiring the immediate, local presence of an administrative user. In accordance with the present disclosure, a remote management peripheral device may also be used to directly command the erasure or backup of storage drives located on the host computing devices of the fleet. More specifically, the remote management peripheral device can, in accordance with a configuration option selected by an administrative user, generate a command to the BIOS of individual host computing devices within a fleet of host computing devices to erase or backup their respective storage drives. Such a command is generally referred to herein as a “BIOS command,” and following receipt by a host computing device, the BIOS command may be executed by the BIOS of the host computing device to erase or backup the storage drive(s) of the host computing device. By leveraging the presence and functionality of the BIOS at each host computing device in the fleet, the remote management peripheral device centralizes and automates a storage drive management task that is otherwise performed on a host computing device-by-host computing device basis via a tool provided in the host computing device's local operating system, via a pre-boot interface accessed by a local administrative user with a security key, or via specific computer-executable instructions for storage drive management located on the host computing device.

It will be appreciated that the BIOS of a host computing device initializes and tests the hardware of the host computing device and loads the operating system of the computing device after the host computing device powers on. This process may be referred to as the boot process, or “booting” or “boot up.” This process may be repeated when the host computing device is restarted, in which case the process may be referred to as a “reboot.” The BIOS may have access to data within the storage of the host computing device. Under direction, the BIOS may implement actions that affect the storage of data within the storage drives of the host computing device. For example, a BIOS may include access to the C:\ or D:\ drives or Disk 1 or Disk 0 of the host computing device (although a disk such as “Disk 1” may be a physical storage device and a storage drive such as “C:\” may be a file system that may exist on part of, or many disks, the term “storage drive” as used herein may encompass either or both unless specifically stated otherwise). Thus, by executing a BIOS command for erasure that is received from the remote management peripheral device, the host computing device may erase the data stored on the aforementioned storage drives during the next boot up or reboot of the host computing device. If the BIOS command received from the remote management peripheral device is a backup command (rather than an erase command), the remote management peripheral device may also provide the BIOS of the host computing device with additional information, e.g., a unified extensible firmware interface shell (EFI Shell), to enable backup of specific storage drives or specific folders within the host computing device's storage drives to an alternative storage location.

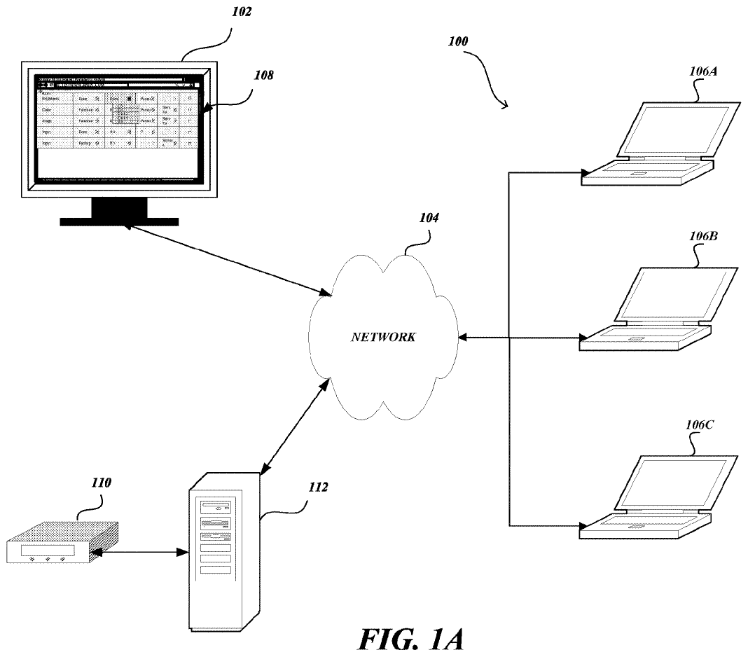

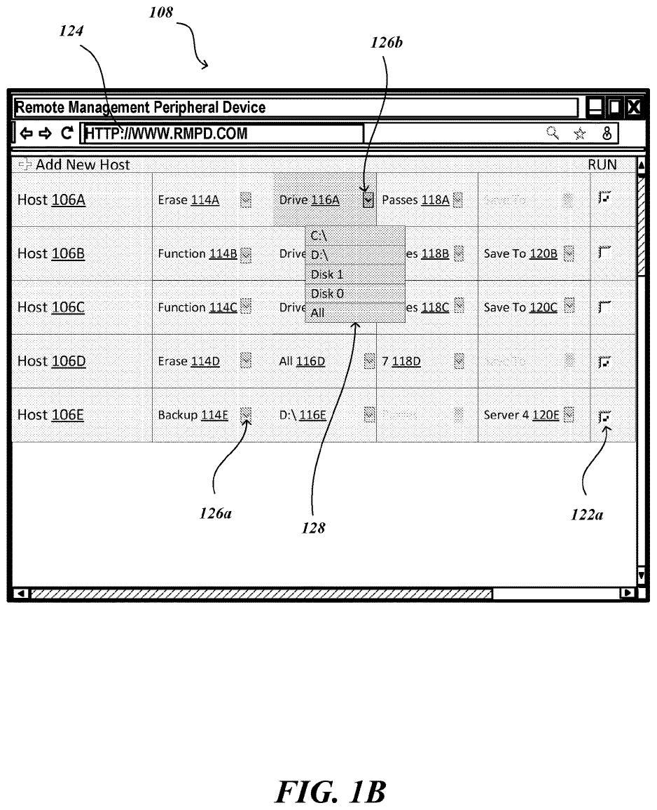

FIG. 1A depicts an example fleet 100 of host computing devices 106 (e.g., 106A, 106B and 106C) that can communicate via a network 104 and be managed by a remote management peripheral device 110 in accordance with configuration options selected at an administrative computing device 102. It will be appreciated that the fleet 100 of host computing devices may include workstation computers, laptop computers, notebook computers, desktop computers, any other computing devices capable of communicating via a network, or a combination thereof. It will also be appreciated that each host computing device 106 of the fleet 100 can communicate directly with a separate remote management peripheral device 110 such that there is a one-to-one relationship between host computing devices 106 and remote management peripheral devices 110. In some examples, the remote management peripheral device 110 may communicate directly with the host computing devices 106 and the administrative computing device 102 via the network 104 or indirectly via a server 112 that communicates with the host computing devices 106 and administrative computing device 102. In some examples, the remote management peripheral device 110 may communicate directly with the host computing devices 106 through wired or wireless communication methods. For example, the remote management peripheral device 110 may be connected using wired connections including, but not limited to twisted pair wires, coaxial cable, ethernet, fiber-optic, and category cables. The remote management peripheral device 110 may be connected using wireless connections including, but not limited to satellite communication, infrared communication, broadcast radio, microwave communication, WI-FI communication, BLUETOOTH communication, and mobile communication systems. The administrative computing device 102 can be any computing device capable of communicating via the network 104 with the remote management peripheral device 110, such as a laptop, tablet, notebook, workstation, desktop computing device, personal digital assistant (PDA), hybrid PDA/mobile phone, smart wearable device (such as a smart watch), mobile phone, smartphone, etc. Although depicted in FIG. 1A as a separate device, the administrative computing device 102 can be the same as the remote management peripheral device 110 and/or the remote management peripheral device 110 can have the same administrative capabilities as the administrative computing device 102.

To enable interaction between the administrative computing device 102 and the remote management peripheral device 110, the remote management peripheral device 110 can include a frontend interface that enables an administrative user, via the administrative computing device 102, to select configuration options for configuring storage drives of the host computing devices 106 in the fleet 100. In some examples, the frontend interface generates and provides to the administrative computing device 102 graphical user interfaces, such as graphical user interface 108 depicted in FIG. 1A. In other examples, the frontend interfaces communicate with the administrative computing device 102 via a command-line interface (CLI), or an application programming interface (API). The frontend interface can ensure that the administrative computing device 102 and/or users of the administrative computing device 102 are properly authorized. In the example depicted in FIG. 1A, the graphical user interface 108 is displayed at the administrative computing device 102 via a web browser or a local application. As an accessible webpage or application, it should be appreciated that, in some examples, the administrative computing device 102 need not be configured only to communicate with the remote management peripheral device 110, rather it can be a non-dedicated computing device that interfaces with the remote management peripheral device 110 to enable selection of configuration options for the storage drives of the host computing devices 106.

FIG. 1B depicts the example graphical user interface 108 in more detail. As illustrated, the graphical user interface 108 can be configured as a webpage accessed via a Uniform Resource Locator (URL) 124 from the administrative computing device 102. Using the graphical user interface 108, a user of the administrative computing device 102 can select configuration options 114 for configuring storage drives of the host computing devices 106 in the fleet 100. In the illustrated example, the graphical user interface 108 includes a configuration option 114 for multiple host computing devices 106 in the fleet 100. More specifically, for each host computing device 106 presented on the graphical user interface 108, a configuration option 114 may be presented. The configuration option 114 for each host computing device can be selected from a drop-down menu (not shown) displayed in response to selecting a down-arrow control, such as down-arrow control 126a. The configuration option 114 selected may be to erase storage drives of the corresponding host computing device 106 (e.g., configuration options 114A and 114D corresponding to host computing devices 106A and 106D, respectively), backup storage drives of the correspondent host computing device 106 to a new location (e.g., configuration option 114E corresponding to host computing device 106E), or apply some other function to the storage drives of the corresponding host computing device (e.g., configuration options 114B and 114C corresponding to host computing devices 106B and 106C, respectively).

The graphical user interface 108 may further include selectable configuration parameters 116, 118 and 120 for the configuration option 114 selected for each host computing device 106. The configuration parameters 116, 118 and 120 for each host computing device 106 can be selected from a drop-down menu displayed in response to selecting a down-arrow control. For example, if the configuration option selected is the configuration option 114A to erase a storage drive of the host computing device 106A, the user can further select a configuration parameter 116A identifying the storage drive(s) of the host computing device to be erased and a configuration parameter 118A identifying the number of times the host computing device is to erase each identified storage drive (the number of times the host computing device is to erase a storage drive may also be referred to as a number of “passes”). As shown in FIG. 1B, in response to selecting a down-arrow control 126b, a drop-down menu 128 is displayed identifying the storage drives that are located on the host computing device 106A or otherwise accessible by the BIOS of the host computing device 106A, e.g., C:\ or D:\ drives or Disk 1 or Disk 0. Accordingly, the user of the administrative computing device 102 can select anyone, a combination of, or all of the storage drives included in the drop-down menu 128 to which the user wishes the erase configuration option 114A to be applied. Similarly (although not shown), the user can select a number of passes to make over the selected storage drives when they are being erased via a drop-down menu presented in connection with configuration parameter 118A.

In yet another example, if the configuration option selected is the configuration option 114E to backup storage drives of the host computing device 106E, the user can further select a configuration parameter 116E identifying the storage drive(s) of the host computing device to be backed up to another storage location and a configuration parameter 120E identifying the storage location. Again, the user of the administrative computing device 102 can select anyone, a combination of, or all of the storage drives included in a drop-down menu to which the user wishes the backup configuration option 114E to be applied. Similarly, the user can select a storage location to which backup the selected storage drives when they are being erased via a drop-down menu or other form of input presented in connection with configuration parameter 120E. In the example depicted in FIG. 1B, the user of the administrative computing device 102 has selected storage drive D:\ for backup to “server 4.” It will be appreciated that “server 4” may be the server 112 depicted in FIG. 1A to which the remote management peripheral device 110 is connected.

As also illustrated in FIG. 1B, after the user of the administrative computing device 102 has selected the configuration options and configuration parameters for the desired host computing devices 106 of the fleet 100, the user may initiate communication of the selected options and parameters to the remote management peripheral device 110 by selecting a run box 122, such as run box 122a in the graphical user interface 108. It will further be appreciated that while selection of configuration options 114 and configuration parameters 115, 118 and 120 have been described herein as enabled via the use of drop-down menus and down-arrows, the configurations options and configuration parameters can be presented, selected, and communication of them initiated via a variety of input controls, commands, and features, depending on the type of frontend interface provided by the remote management peripheral device without departing from the scope of the present disclosure. In addition, the remote management peripheral device 110 may provide, and the graphical user interface 108 may include, one, a subset or all of the host computing devices 106 in the fleet 100. Moreover, it will be appreciated that the remote management peripheral device 110 may provide, and the graphical user interface 108 may include, multiple configurations options 114 for each host computing device 106. The remote management peripheral device 110 may also provide, and the graphical user interface 108 may include, additional, different, or fewer selectable configurations parameters for each of the configuration options. In order to provide the configuration options and configuration parameters for the host computing devices 106, the remote management peripheral device 110 may interrogate each host computing devices 106 to identify its storage drives of and obtain related information regarding the storage drives as described in more detail below.

Returning to FIG. 1B, after the user of the administrative computing device 102 has selected the configuration options and the remote management peripheral device 110 has received the selected configuration options for the desired host computing device(s) 106 of the fleet 100, the remote management peripheral device 110 can generate a BIOS command to be executed by the BIOS of the desired the host computing device(s) 106. For example, if configuration option 114A to erase storage drives of the host computing device 106A was selected, the remote management peripheral device 110 can generate a BIOS command to erase the storage drive(s) of host computing devices 106A in accordance with the configuration parameters 116A (identifying the drive(s) to be erased) and 118A (identify the number of passes over the identified drives on erase). Similarly, if configuration option 114E was selected, the remote management peripheral device 110 can generate a BIOS command to back up the storage drives(s) of host computing device 106E in accordance with the configuration parameters 116E (identifying the drive(s) to be backed up) and 120E (identifying the storage location(s) to which the identified drives are to be backed up). The BIOS command can further include supplemental instructions for erasing and backing up the drives and disks of the host computing devices 106. The remote management peripheral device 110 can then transmit the BIOS commands to the respective host computing devices 106 for execution during the next boot up. This avoids the need for the host computing devices 106 to be rebooted locally by a user, or for the local operating systems to run a disk management tool, to erase or backup host computing devices 106 on a device-by device basis.

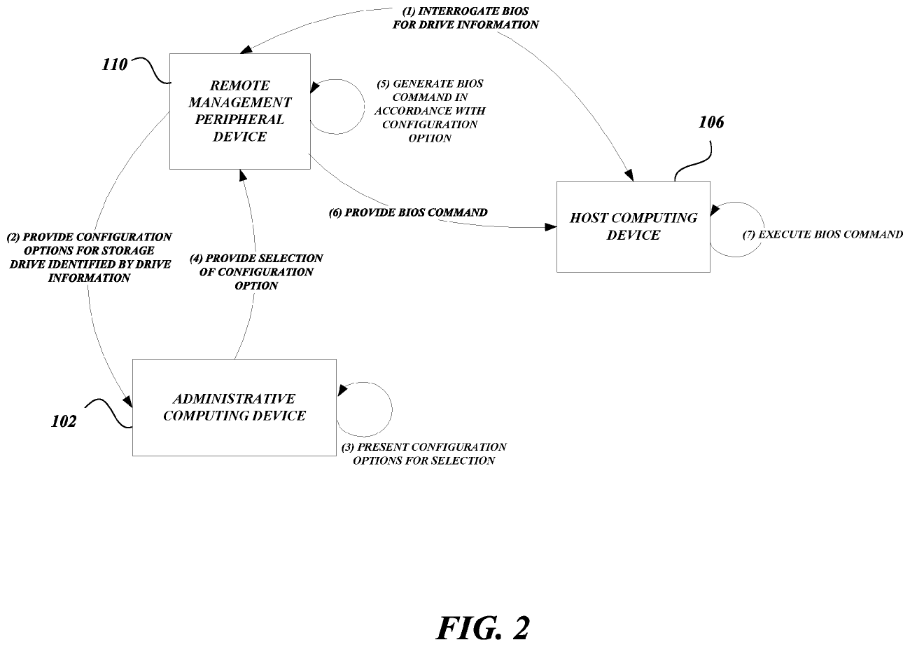

FIG. 2 is a block diagram depicting example interactions between an administrative computing device 102, a remote management peripheral device 110, and a host computing device of the fleet 100 as shown in FIG. 1A, when a configuration option is selected at the administrative computing device 102 via the user interface 108 as shown in FIG. 1B and a BIOS command is generated by the remote management peripheral device 110. To enable selection of the configuration option and creation of the BIOS command by the remote management peripheral device 110, the remote management peripheral device can utilize information about the host computing device 106 to identify BIOS commands that are native or otherwise recognizable or usable by host computing devices 106 of the fleet of computing devices.

In this regard, at (1) the remote management peripheral device 110 interrogates the BIOS of a host computing device 106 via the network 104 for drive information regarding its storage drives. The interrogation request from the remote management peripheral device 110 requests that the host computing device 106 provides BIOS information and drive information stored within the BIOS of the host computing device 106 that would be usable for the remote management peripheral device 110 to generate a BIOS command to erase or backup the storage drives of the host computing device 106. For example, the drive information could include whether data is stored on the storage drives of the host computing device 106. The drive information can be for a single, some, or all of the storage drives accessible by the host computing device 106 and capable of being managed by the remote management peripheral device 110 remotely. For example, the storage drives can include: C:\, D:\, Disk 1, or Disk 0, all of the aforementioned storage drives, or a subset of the aforementioned storage drives of the host computing device 106. The drive information can include information on the capacity of the storage drives and/or the percentage of capacity of the storage drives that is filled with data or that is free. From the drive information received from the BIOS of the host computing device 106 in response to the interrogation, the remote management peripheral device 110 can identify the local storage drive(s) of the host computing device 106.

At (2), the remote management peripheral device 110 provides configuration options for the local storage drive(s) identified using the drive information to the administrative computing device 102. The configuration options may include the BIOS information collected from the host computing device 106 and actions for the storage drives of the host computing device 106 that can be commanded by the remote management peripheral device 110 remotely. The configuration options for the storage drive(s) can be transmitted from the remote management peripheral device 110 to the administrative computing device via the network 104 or through another wired and/or wireless connection. In the example depicted in FIG. 1A, the remote management peripheral device 110 is connected the server 112 and communications with the administrative computing device 102 indirectly via the network 104. In other examples, the remote management peripheral device communicates directly with the remote management peripheral device 110 via the network 104 or the administrative computing device 102 and the remote manage peripheral device are the same device. At (3), the administrative computing device 102 presents the configuration options to a user of the administrative computing device 102 for selection of a configuration option to configure the local storage drive(s) of respective host computing device(s) of the fleet 100. The configuration parameters can be presented in a graphical user interface 108, such as depicted in FIGS. 1A and 1B.

At (4), the administrative computing device 102 provides the selected configuration option, including the configuration parameter(s) selected for the configuration option, to the remote management peripheral device 110. At (5), the remote management peripheral device 110 generates a BIOS command to configure the local storage drive(s) of the host computing device 106 in accordance with configuration option and the configuration parameters selected for the configuration option. For example, if the configuration option for erasing storage drive(s) of the host computing device 106 is selected at the administrative computing device 102, the remote management peripheral device 110 can generate an erase BIOS command that includes a drive identifier for each of the storage drive(s) identified by the configuration parameters, the number of passes to erase the storage drive(s) specified by the configuration parameters, and a command to the host computing device 106 for the BIOS of the host computing device to execute the erase function of the BIOS according to the drive identifier and the number of passes. If the configuration option for backing up storage drive(s) of the host computing device 106 is selected at the administrative computing device 102, the remote management peripheral device 110 can generate a backup BIOS command that a drive of the host computing device 106, the remote management peripheral device 110 can generate a backup BIOS command that includes a drive identifier for each of the storage drive(s) identified by the configuration parameters create and a location specified by the configuration parameters to which to back up the storage drive(s). In some examples, the backup BIOS command can further include a backup script to run on the host computing device 106 that directs backup of the identified storage drive(s) to the specified storage location, e.g., to a local or remote storage drive, a server, the administrative computing device 102, the remote management peripheral device 110 itself, or to a storage service, such as a cloud computing storage service.

At (6), the remote management peripheral device 110 provides the BIOS command to the host computing device 106 for the host computing device 106 to execute at (7). The command can be transmitted via the network 104 or through another a wired/and or wireless connection. Once received at the host computing device 106, the BIOS of the host computing device 106 can execute the BIOS command during the next boot or reboot of the host computing device 106. In some examples, receipt of the BIOS command can trigger and immediate reboot of the host computing device 106. Accordingly, by remotely leveraging the BIOS of the host computing devices 106 through the use of BIOS comments, the remote management peripheral device 110 avoids the need for a user to access the BIOS of the host computing device locally during the boot process to erase or backup the storage drives.

For example, when the configuration option for erasure is selected, the remote management peripheral device 110 can generate a BIOS command that instructs the BIOS of the host computing device 106 to erase the local storage drive(s) identified by the configuration parameters of the configuration option. Accordingly, the BIOS of the host computing device 106 executes an erase function that exists within it on the identified storage drive(s). Further the BIOS command can instruct the BIOS of the host computing device 106 to make the number of erase passes over the identified storage drive(s) specified by the configuration parameters. In some examples, after the BIOS of the host computing device 106 has executed the erase function as directed by the BIOS command, the BIOS can restart the host computing device 106 or otherwise proceed with reboot of the host computing device 106.

As another example, when the configuration option for backup is selected, the remote management peripheral device 110 can generate a BIOS command that instructs the BIOS of the host computing device 106 to back up the local storage drive(s) identified by the configuration parameters of the configuration option. Accordingly, the BIOS of the host computing device 106 executes a backup function that exists within it on the identified storage drive(s). Further the BIO command can instruct the BIOS of the host computing device 106 to back up the identified storage drive(s) to a storage location specified by the configuration parameters. As mentioned above, the storage location (which may also be referred to herein as a “storage medium”) can be another storage drive of the host computing device 106, another host computing device in the fleet 100, a server (such as server 112), the remote management peripheral device 110 itself, the administrative computing device 102, or a storage service. In some examples, once the backup is complete, the BIOS of the host computing device 106 may then erase the identified storage drive(s).

In some examples, after the BIOS of the host computing device 106 executes the BIOS command, the host computing device 106 can send to, and the remote management peripheral device 110 can receive, a completion message. The remote management peripheral device 110 may then provide the completion message to the administrative computing device 102 to notify the user of the administrative computing device 102 that the configuration option has been implemented as directed. In some examples, the notification can be displayed on the graphical user interface 108 presented on the administrative computing device 102. In some examples, the remote management peripheral device 110 may receive an error message from the host computing device 106 if the host computing device 106 is unable execute the BIOS command as directed. The error message can include details on the error or the actions that were completed prior to the error.

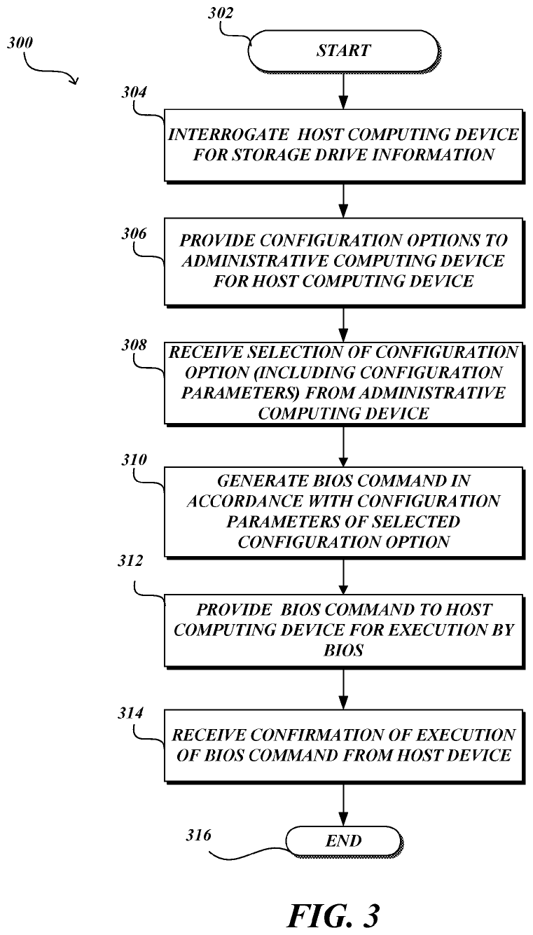

FIG. 3 is a flow diagram depicting an example routine 300 implemented by the remote management peripheral device 110 for generating a BIOS command for a host computing device 106 in accordance with a configuration option selected at the administrative computing device 102, and providing the BIOS command to the host computing device 106 for execution by the BIOS of the host computing device 106. In some examples, the routine 300 is one of multiple routines implemented by remote drive management tool stored in memory of the remote management peripheral device 110, executed by a processor of the remote management peripheral device 110 and used to manage various aspects of the storage drives of the host computing devices 106 among the fleet 100. While FIG. 3 illustrates an example routine 300 executed by remote management peripheral device 110 for generating a BIOS command in accordance with a configuration option for one of multiple host computing devices 106 in a fleet 100, it will be appreciated that the remote management peripheral device 110 may generate may receive configuration options for multiple host computing devices 106 of the fleet 100, and thus, generate BIOS commands for multiple host computing devices, serially, concurrently, or otherwise.

The routine 300 starts at block 302 and proceeds to block 304 where the remote management peripheral device 110 interrogates the BIOS of the host computing device 106 for drive information regarding its storage drives. The drive information can be for a single, some, or all of the storage drives located on, or otherwise accessible by, the host computing device 106. The interrogation of the BIOS includes both requesting the drive information from the host computing device 106 and receiving the drive information from the host computing device 106 via the network 104 or a wired or wireless connection. For example, the remote management peripheral device 110 can interrogate the host computing device 106 for a single drive, such as the C:\ drive. In return, the host computing device 106 can return drive information for the C:\ drive. Drive information can include the capacity of the C:\ drive empty, the percentage of the C:\ drive that is filled (or free), access information for the C:\ drive, commands within the BIOS that can be used by the BIOS on the C:\ drive, etc. In other examples, the drive information includes drive information for multiple storage drives. For example, the drive information can include information for the C:\ drive and Disk 1 of the host computing devices 106. Upon receiving the drive information, the remote management peripheral device 110 can further identify a first capacity as being associated with the C:\ drive and a second capacity as being associated with Disk 1.

Next, at block 306, the remote management peripheral device 110 provides configuration options for the storage drive(s) of the host computing device 106 to the administrative computing device 102 for selection. For example, based on the drive information obtained from the host computing device 106, the remote management peripheral device 110 can generate a configuration option for the storage drive(s) of the host computing device 106 to erase, backup or apply some other function to the storage drive(s) of the host computing device 106 identified by the drive information. The configuration option may also include configuration parameters for further selection, depending on the user's selection of an erase, backup, or other function as the configuration to be applied to the storage drive(s). As discussed above in connection with FIG. 1B, the remote management peripheral device 110 may provide, the administrative computing device 102 may present, and an administrative user may select, the configuration option to erase storage drive(s) of the host computing device 106, and then select as a first configuration parameter the storage drive(s) of the host computing device 106 to be erased, and select as a second configuration parameter the number of passes desired to erase the selected storage drives. Similarly, the remote management peripheral device 110 may provide, the administrative computing device 102 may present, and an administrative user may select, the configuration option to backup storage drive(s) of the host computing device 106, and then select as a first configuration parameter the storage drive(s) of the host computing device 106 to be backed up, and select as a second configuration parameter the storage location to which to back up the selected storage drive(s).

Returning to FIG. 3, the remote management peripheral device 110, at block 308, receives a selection of a configuration option for a host computing device 106, including the selected configuration parameters, from the administrative computing device 102. At block 310, the remote management peripheral device 110 generates a BIOS command in accordance with the option of the configuration parameter(s). The BIOS command is executable by the BIOS of the host computing device 106 to configure the storage drives in accordance with the function and configuration parameters of the selected configuration option. In some examples, the remote management peripheral device 110 can generate more than one BIOS command in accordance with the selected configuration option. For example, if the user of the administrative computing device 102 selected the configuration option to erase and selected two storage drives to be erased, the remote management peripheral device 110 can generate a first BIOS command to erase a first of the two storage drives and a second BIOS command to erase a second of the two storage drives. As yet another example, the user may have selected two configuration options for the same host computing device 106, with a first configuration option to erase the first storage drive and a second configuration option to back up the second storage drive. In this example, the remote management peripheral device 110 can generate a first BIOS command to erase the first storage drive and a second BIOS command to back up the second storage drive.

When the selected configuration option received by the remote management peripheral device 110 is to erase storage drive(s) of the host computing device 106, the remote management peripheral device 110 can generate a BIOS command to erase the storage drive(s) identified by the configuration parameters of the configuration option as noted above. The erase BIOS command generated by the remote management peripheral device 110 can also direct the BIOS to apply the erase function to the identified storage drive(s) according to the number of passes specified by the configuration parameters of the configuration option. In one example, the BIOS command to erase is a “SecureErase” command recognizable and executable by the BIOS of the host computing device 106 to securely erase or remove all data from or “wipe” a storage drive. “Secure erasing” erases all or part of a storage drive so that the data it contained is difficult or impossible to recover. In some examples, secure erasing may alternatively, or in addition, write fake data over every sector of the storage drive in order to make the prior data difficult to recover. Depending on the type or manufacturer of the host computing device, such a BIOS command may be known as a “Data Wipe” command. In yet other examples, however, the BIOS command to erase a storage drive does not require securing erasing. In additional examples, the BIOS command can, using a command recognizable and executable by the BIOS of the host computing device 106, direct the host computing device 106 to erase using a non-secure erase function. For example, the BIOS command can be a format or a quick format command. Using a format command, the BIOS can format a drive or disk and, in the process, overwrite all data with zeros. Such commands may not benefit from multiple passes. Using the quick format command to remove data from a drive or disk of the BIOS of the host computing device 106 does not immediately erase the data, however it marks the data to be overwritten, thus erasing the data over time as additional data is written.

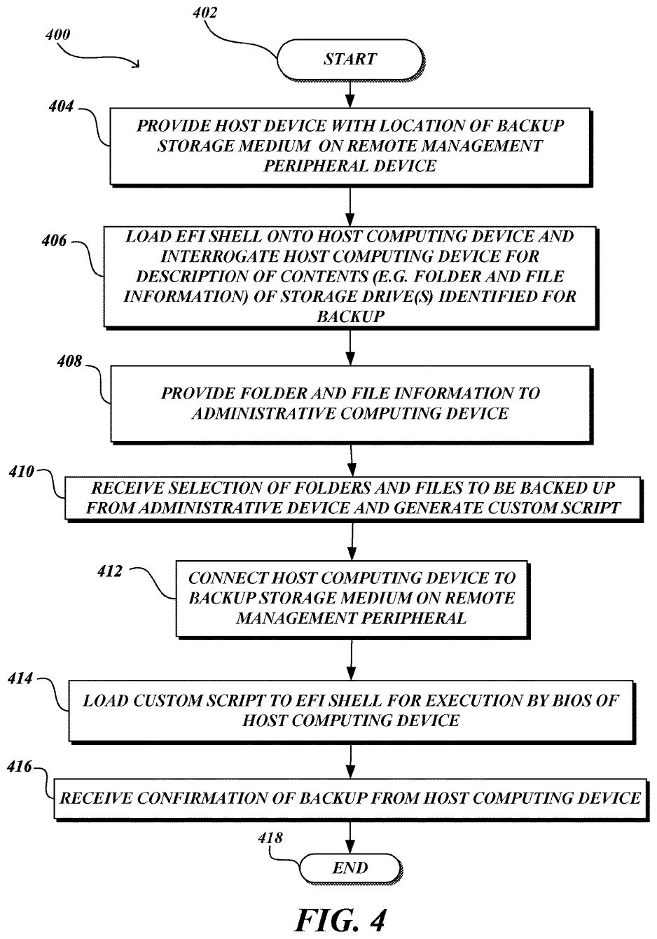

When the selected configuration option received by the remote management peripheral device 110 is to backup storage drive(s) of the host computing device 106, the remote management peripheral device 110 can generate a BIOS command to back up the storage drive(s) identified by the configuration parameters of the configuration option as noted above. The backup BIOS command generated by the remote management peripheral device 110 can also direct the BIOS to apply the backup the identified storage drive(s) to the storage location by the configuration parameters of the configuration option. Depending on the storage location, however, additional information may be necessary for the host computing device 106 to effectively backup the date stored on its identified storage drive(s). Accordingly, the remote management peripheral device 110 may also provide the BIOS of the host computing device 106 with additional information, e.g., a unified extensible firmware interface shell (EFI Shell), to enable backup of specific storage drives or specific folders within the host computing device's storage drives to an alternative storage location, as discussed below in connection with FIG. 4.

Returning to FIG. 3, at block 312, the remote management peripheral device 110 provides the BIOS command to the host computing device 106 for execution by the BIOS of the host computing device 106. The BIOS of the host computing device 106 can execute the BIOS command using existing functions in the BIOS. For example, if the BIOS command is an erase command, the BIOS can execute a native secure erase function, such as SecureErase, on the storage drive(s) identified by the configuration parameters and for the number of passes specified by the configuration parameters. Similarly, if the BIOS command is a backup command, the BIOS can execute a backup function (or at least initiate a backup process) to copy the contents of the identified storage drive(s) to the storage location specified by the configuration parameters. In some examples, the BIOS command may include additional information from the remote management peripheral device 110 for use by the host computing device 106 to authenticate the BIOS command. For example, the BIOS command may require a passcode or key to be provided to the host computing device 106 that, when received, indicates to the host computing device 106 that the sender of the BIOS command is an authorized sender. In further examples, authentication may utilize authentication protocols such as transport layer security (TLS) or secure socket layer security (SSL) which may implement a handshake protocol between the remote management peripheral device 110 and the host computing device 102. In some examples, the host computing device 106 may require information on the user of the administrative computing device 102 to prove the user of the administrative computing device 102 is authorized to select options and configuration parameters. Such information can be, but is not limited to, biometric authentication, token authentication, two factor authentication, password-based authentication, and single sign-on authentication. In response confirming authorization, the host computing device may implement the BIOS command to erase or backup the identified storage drive(s). Once erasure or backup are completed, the remote management peripheral device 110 may receive at block 312 a confirmation of the execution of the BIOS command from the host computing device 106. In some examples, this confirmation is passed on or otherwise reported to the administrative computing device 102. The routine 300 then ends in a block 316.

FIG. 4 is a flow diagram depicting an example routine 400 implemented by the remote management peripheral device 110 for providing a host computing device 106 with information related to backing up the storage drive of the host computing device when the BIOS command is a backup command. The routine 400 may be one of multiple routines implemented by the remote drive management tool stored in memory of the remote management peripheral device 110, executed by a processor of the remote management peripheral device 110, and used to manage various aspects of the storage drives of the host computing devices 106 among the fleet 100. The routine 400 may be executed by the remote management peripheral device 110 in connection with generating a backup BIOS command based on the selection of a backup configuration option by a user the administrative computing device 200. In the example illustrated in FIG. 4, the backup configuration option selected by the user includes a configuration parameter that identifies a storage medium on the remote management peripheral as the storage location to which the storage drive(s) of the host computing device 106 is to be backed up.

The routine 400 starts at block 402 and proceeds to a block 404 where, as part of the backup of BIOS command or subsequent to the sending the host computing device 106 the backup BIOS command, the remote management peripheral device 110 provides the host computing device with the location of the backup storage medium on the remote management peripheral device 110. At block 406, the remote management peripheral device 110 loads a unified extensible firmware interface (EFI) shell onto the host computing device 106 while interrogating the host computing device 106 for a description of contents, e.g., folder and file information, of the storage drive of the host computing device 106 to be backed up. The EFI shell, once loaded onto the host computing device 106 can act as an interface between the operating system and BIOS of the host computing device 106 and the remote management peripheral device 110. Accordingly, the EFI can be utilized as an environment to access the BIOS of the host computing device 106 and run boot and pre-boot applications.

Using the EFI shell as an environment to access the BIOS of the host computing device 106, the BIOS of the host computing device can boot directly into the EFI shell and become accessible to the remote management peripheral device 110. Once the BIOS is booted into the EFI shell, the remote management peripheral device 110 can access information on the storage drive(s) of the host computing device 106 and determine the location and contents of folders and files that are to be included in a backup. Accordingly, at block 408, the remote management peripheral device 110 provides the description of contents information collected from the host computing device 106 via the EFI shell to the administrative computing device 102. The description of contents can include sizes of the folders and files, names of the folders and files, locations such as the storage drive the folders and files are within, the intended backup storage medium, and other information that can be utilized by the remote management peripheral device 110 to create a command for the host computing device 106.

At block 410, the remote management peripheral device 110 receives a selection of folders and files to be backed up from the administrative computing device 102. Using the selection of folders and files and other information from the administrative computing device 102, the remote management peripheral device 110 can create a custom script that will facilitate the backup of the selected folders and files to the storage medium on the remote management peripheral device 110. After receiving the selection of folders and files from the administrative computing device 102 and generating the custom script, the remote management peripheral device 110 establishes a connection at block 412 between the host computing device 106 and the backup storage medium on the remote management peripheral device 110. After the connection is made, the remote management peripheral device 110 loads the custom script to the EFI shell at a block 414. The custom script can then be executed by the BIOS of the host computing device 106 to copy the selected files and folders to the backup storage medium on the remote management peripheral device 110.

After backup is complete, the remote management peripheral device 110 can receive confirmation of the backup from the host computing device 106 in a block 416. In some examples, this confirmation is passed on or otherwise reported to the administrative computing device 102. In other examples, the host computing device 106 can be configured to provide notifications of a failure in the backup process. The failure notification can further include specifics about when the failure occurred and what folders and files had been backed up before the failure. After receiving a failure notification, the remote management peripheral device 110 may transmit the backup BIOS command again to attempt to retry the backup. The remote management peripheral device 110 may track the number of failure notifications and stop attempting to retry the backup BIOS command at a set value. In some examples, upon failure, the remote management peripheral device 110 may transmit the failure notification to the administrative computing device 102 to notify the administrative user of the failure. The routine 400 ends at block 418.

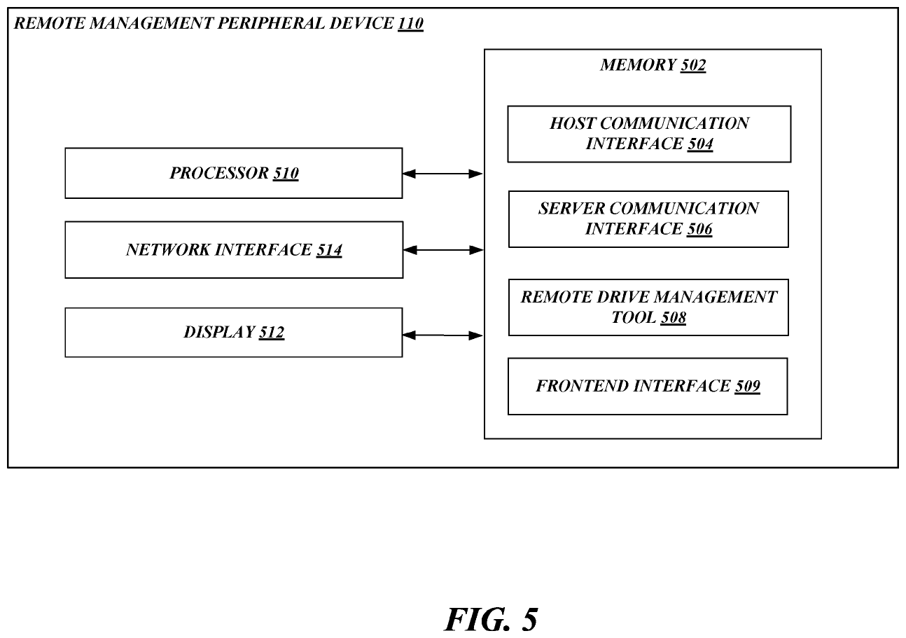

FIG. 5 is a block diagram of an example architecture for a remote management peripheral device 110 that generates BIOS commands in accordance with a configuration option selected at the administrative computing device 102. The example architecture of remote management peripheral device 110 in FIG. 5 includes an arrangement of computer hardware and computer-readable instructions that may be used to implement aspects of the present disclosure. In some examples, the remote management peripheral device 110 includes a processor 510, display 512, network interface 514, and memory 502, all of which may communicate with one another by way of an internal communication bus. The display 512 may be any type of display panel suitable for use with a computing device, including, without limitation, a light emitting diode (LED) display panel, individually placed LED indicators, cathode ray tube (CRT) display panel, liquid crystal display (LCD) panel, thin-film-transistor liquid crystal display (TFT LCD) panel, plasma display panel, or organic light emitting diode (OLED) display panel. In some examples, the display 512 may be both an input and output device and the display panel may be a touch panel that accepts touch input. The network interface 514 may be a hardware device, such as a card, adapter, circuit board or chip, which enables the remote management peripheral device 110, the administrative computing device 102, or other devices or servers via network 104 or other networks or communication systems.

The processor 510 may execute computer-executable instructions stored in RAM, ROM and/or other persistent or non-transitory memory 502 to implement examples of the present disclosure. The memory 502 of the remote management peripheral device 110 may include a host communication interface 504, a server communication interface 506, a remote drive management tool 508, and a frontend interface 509. The host communication interface 504 may include computer-executable instructions appropriate to enable the remote management peripheral device 110 to communicate with other computing devices, such as host computing devices 106 and the administrative computing device 102, via the network interface 514 and network 104 or through direct communication methods. The server communication interface 506 may include computer-executable instructions appropriate to enable the remote management peripheral device 110 to communicate with server 112 via a direct communication connection or with other servers, the network interface 514 and network 104. The remote drive management tool 508 can be used to provide configuration options to, and receive selections of configuration options from, the administrative computing device 102. In addition, the remote drive management tool may generate BIOS commands based on the selected configuration options that instruct the BIOS of host computing devices 106 to erase or backup the storage drive(s) of the host computing devices 106. The frontend interface 509 can enables an administrative user, via the administrative computing device 102, to select configuration options for configuring storage drives of the host computing devices 106. In an example, the frontend interface 509 provides the administrative computing device 102 with a graphical user interface with which an administrative user can interact to select configuration options. In other examples, the frontend interface 509 communicates with the administrative computing device 102 via a CLI or API.

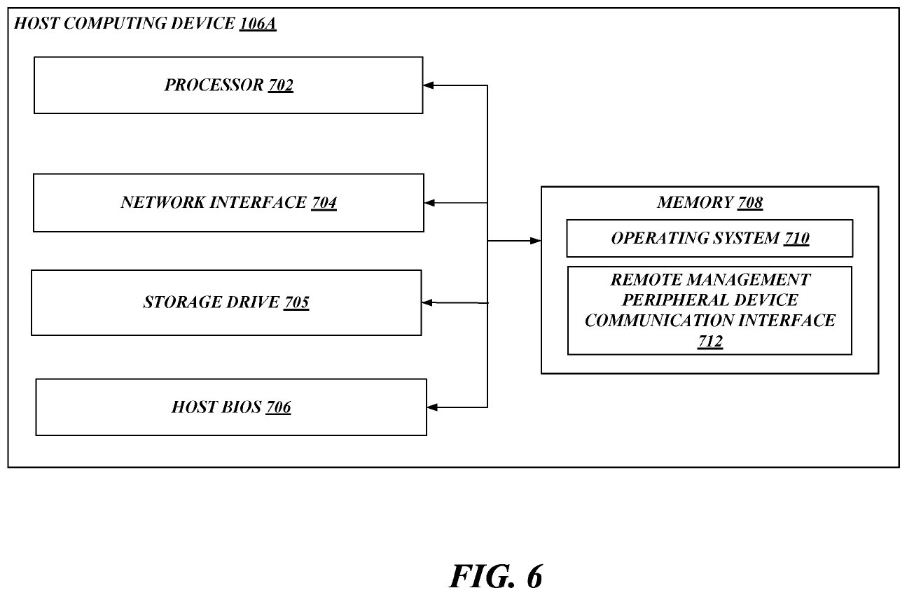

FIG. 6 is a block diagram of an example architecture of a host computing device 106 that executes a BIOS command received from the remote management peripheral device 110. The general architecture of host computing device 106 depicted in FIG. 6 includes an arrangement of computer hardware and computer-executable instructions that may be used to implement aspects of the present disclosure. In some examples, the host computing device 106 may include more (or fewer) components than those shown in FIG. 6. As illustrated, the host computing device 106 includes a processor 702, a network interface 704 (e.g., implemented using a card, adapter, circuit board or chip), a storage drive 705, a BIOS 706, and a memory 708, all of which may communicate with one another by way of an internal communication bus. Although not depicted, the host computing device 106 may also include its own multimedia display that may or may not be used in conjunction with the remote management peripheral device 110 and the administrative computing device 102. The network interface 704 may provide connectivity to networks or other communication systems, such as the Internet. The processor 702 may thus receive information and instructions from other computing systems or services via the network 104.

The storage drive 705 may include data captured on the host computing device 106A. Data on the storage drive 705 may be divided into folders and files that can be found during interrogation of the BIOS 706 of the host computing device 106, by the remote management peripheral device 110. The storage drive 705 is accessible and may be commanded by the BIOS 706 of the host computing device 106. The BIOS 706 can be accessed through an EFI shell and can run an EFI script as mentioned above. Further, the BIOS 706 can include erase commands that can be activated to erase the storage drive 705.

The memory 708 may include computer-executable instructions that the processor 702 executes in order to implement examples in the present disclosure. The memory 708 includes RAM, ROM and/or other persistent or non-transitory memory and may store an operating system 710 that provides computer-executable instructions for use by the processor 702 in the general administration and operation of the host computing device 106. The memory 780 may include a remote management peripheral device communication interface 712 which may enable the host computing device 106 to communicate with the remote management peripheral device 110 via a direct communication connection or via a network, such as network 104. The memory 708 may further include computer-executable instructions and other information for implementing aspects of the present disclosure.

It is to be understood that not necessarily all objects or advantages may be achieved in accordance with any particular example described herein. Thus, for example, those skilled in the art will recognize that certain examples may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including specific computer-executable instructions, which are executed by a computing system. The computing system may include at least one computer or processor. The code modules may be stored in any type of non-transitory computer-readable medium or other computer storage device. Some or all the methods may be embodied in specialized computer hardware.

Many other variations than those described herein will be apparent from this disclosure. For example, depending on the example, certain acts, events, or functions of any of the algorithms described herein can be performed in a different sequence, can be added, merged, or left out altogether (e.g., not all described acts or events are necessary for the practice of the algorithms). Moreover, in certain examples, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various example logical blocks, components and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another example, a processor includes an FPGA or other programmable device that performs logic operations without processing computer-executable instructions. A processor can also be implemented as a combination of computing devices, e.g., a combination of a DSP and a microprocessor, a plurality of microprocessors, at least one microprocessor in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

A basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

Conditional language such as, among others, “can,” “could,” “might,” or “may,” unless specifically stated otherwise, are otherwise understood within the context as used in general to convey that certain examples include, while other examples do not include, certain features, elements, and/or blocks. Thus, such conditional language is not generally intended to imply that features, elements and/or blocks are in any way required for any examples or that any example necessarily includes logic for deciding, with or without user input or prompting, whether these features, elements, and/or blocks are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Any process descriptions, elements or blocks in the flow diagrams described herein and/or depicted in the attached figures should be understood as potentially representing modules, segments, or portions of code which include computer-executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A non-transitory computer readable medium comprising computer-executable instructions that, when executed by a processor of a remote computing device, cause the remote computing device to:
identify a local storage drive of a host computing device;
receive a selection of an option to configure the local storage drive;
generate a basic input/output system (BIOS) command to configure the local storage drive of the host computing device in accordance with the option; and
provide the BIOS command to a BIOS of the host computing device.

2. The non-transitory computer readable medium of claim 1, wherein the BIOS command to configure the local storage drive of the host computing device instructs the BIOS of the host computing device to erase the local storage drive.

3. The non-transitory computer readable medium of claim 2, wherein the BIOS command includes a number of times the host computing device is to erase the local storage drive.

4. The non-transitory computer readable medium of claim 2, wherein in response to the BIOS command, the BIOS of the host computing device erases the local storage drive and restarts the host computing device.

5. The non-transitory computer readable medium of claim 1, wherein the BIOS command to configure the local storage drive of the host computing device instructs the BIOS of the host computing device to back up the local storage drive to a storage medium.

6. The non-transitory computer readable medium of claim 5, wherein the BIOS command identifies the storage medium.

7. A method comprising:
identifying a first storage drive of a plurality of storage drives of a host computing device;
receiving i) a selection of an option to configure the first storage drive, and ii) a configuration parameter in accordance with which a basic input/output system (BIOS) of the host computing device is to configure the first storage drive;
generating a BIOS command to configure the first storage drive of the host computing device in accordance with the option and the configuration parameter; and
transmitting the BIOS command to the host computing device for execution by the BIOS of the host computing device.

8. The method of claim 7, wherein the option is to erase the first storage drive and the configuration parameter a number of times to erase the first storage drive.

9. The method of claim 7, wherein the option is to back up the first storage drive and the configuration parameter specifies a remote storage medium to back up the first storage drive.

10. The method of claim 7, wherein the BIOS command configures the first storage drive, and a second storage drive plurality of storage drives of the host computing device in accordance with the option and the configuration parameter.

11. A computing device comprising:
a communication interface to a remote managing device;
a storage drive;
a basic input/output system (BIOS);
a memory to store computer-executable instructions; and
a processor in communication with the communication interface, the storage drive, the BIOS, and the memory, wherein the processor executes the computer-executable instructions to:
provide drive information for the storage drive to the remote managing device, wherein the drive information is from the BIOS and includes a location and a description of contents of the storage drive;
receive, from the remote managing device via the communication interface, a BIOS command to configure the storage drive of the computing device;
provide the BIOS command to the BIOS of the computing device for execution; and
provide confirmation of execution of the BIOS command.

12. The computing device of claim 11, wherein the BIOS command is at least one of a backup BIOS command and an erase BIOS command.

13. The computing device of claim 11, wherein the processor executes computer-executable instructions to authenticate the remote managing device prior to providing the BIOS command to the BIOS of the computing device for execution.

14. The computing device of claim 11, wherein the processor executes further computer-executable instructions to provide notification of execution failure of the BIOS command.

15. The computing device of claim 11, wherein the BIOS of the computing device utilizes a native BIOS function to execute the BIOS command.
